(19) United States
(12) Patent Application Publication
(10) Pub. No.: US 2019/0277234 A1
(43) Pub. Date: Sep. 12, 2019

(54) FUEL INJECTOR AND METHOD OF ORIENTING AN OUTLET OF THE SAME

(71) Applicant: DELPHI TECHNOLOGIES IP LIMITED, St. Michael (BB)

(72) Inventors: Jordan A. Rivera, Fairport, NY (US); Thomas J. Strauss, Spencerport, NY (US); Eric S. Rowley, Webster, NY (US)

(21) Appl. No.: 15/915,215

(22) Filed: Mar. 8, 2018

(51) Int. Cl. F02M 61/16; F02M 63/00; F02M 61/18; B23P 15/00; G06T 7/73; G06K 7/14; G06K 19/06

(52) U.S. Cl. CPC F02M 61/168; F02M 63/00; F02M 61/182; B23P 15/001; B29C 45/14; G06K 7/1417; G06K 19/06037; F02M 2200/852; G06T 7/74

(57) ABSTRACT

A fuel injector includes a fuel inlet; a fuel injector body; an outlet body having an upstream surface, a downstream surface, and an outlet aperture fluidly connecting the upstream surface to the downstream surface; and a valve assembly which controls flow through the outlet aperture. The outlet body includes a 2-dimensional matrix of cells on the downstream surface and includes a perimeter having a finder pattern and a timing pattern and also includes a field of unpopulated and populated cells within the perimeter which represent bits of data. The 2-dimensional matrix of cells orients the outlet body relative to the fuel injector body.

### TECHNICAL FIELD OF INVENTION

The present invention relates to a fuel injector for supplying fuel to a fuel consuming device and more particularly to a feature and method for orienting an outlet of the fuel injector.

BACKGROUND OF INVENTION

Modern internal combustion engines typically utilize one or more fuel injectors for metering a precise quantity of fuel to be combusted in respective combustion chambers such that the combustion is initiated with a spark from a spark plug or through compression ignition. Combustion of the fuel may be used, for example, to propel a motor vehicle and to generated electricity or drive other accessories in support of operation of the motor vehicle. Fuels in liquid form that are commonly used to power the internal combustion engine include gasoline, alcohol, ethanol, diesel fuel and the like, and blends thereof. Until more recently, fuel injectors commonly referred to as port fuel injectors were predominantly used. Port fuel injectors inject fuel into a port of an intake manifold where the fuel is mixed with air prior to being drawn into the combustion chamber of the internal combustion through an intake valve of the cylinder head. A typical port fuel injector is show in U.S. Pat. No. 7,252,249 to Molnar.

In order to increase fuel economy and reduce undesirable emissions produced by combustion of the fuel, direct injection fuel injectors have been increasing in use. As the name suggests, direct injection fuel injectors inject fuel directly into the combustion chamber. U.S. Pat. No. 8,453,951 to Perry et al. shows a direct injection fuel injector which includes a nozzle tip, hereinafter referred to as outlet body, with individual holes which are sized and shaped to allow a precise amount of fuel therethrough. When such an arrangement is used, it may be desirable to orient the outlet body in the combustion chamber in a predetermined orientation in order for the resulting spray pattern/shape to be oriented in a way that is most beneficial to combustion of the fuel. Furthermore, orientation of the outlet body in the combustion chamber may be determined by the interaction of geometries of a fuel injector body and the internal combustion engine where the fuel injector body is located outside of the combustion chamber. Consequently, in order to ensure proper orientation of the outlet body within the combustion chamber, the fuel injector must be manufactured to ensure that the outlet body is properly oriented with respect to the fuel injector body. It is known to machine a feature on the outlet body which is subsequently used only to align the feature with a complementary feature of the fuel injector body in order to ensure proper orientation between the outlet body and the fuel injector body, and consequently, ensure proper orientation of the outlet body in the combustion chamber when the fuel injector is installed on the internal combustion engine. However, machining the feature on the outlet body adds time to the manufacturing process since the machined feature is only used to align the outlet body with the fuel injector body. Furthermore, tool life is decreased if the same tool that is used to machine the feature on the outlet body is also used to machine other features.

What is needed is a fuel injector and method of manufacturing the fuel injector which minimizes or eliminates one or more of the shortcomings set forth above.

### SUMMARY OF THE INVENTION

Briefly described, a fuel injector for supplying fuel to a fuel consuming device includes a fuel inlet which communicates fuel into the fuel injector; a fuel injector body; an outlet body having an upstream surface, a downstream surface, and an outlet aperture fluidly connecting the upstream surface to the downstream surface; and a valve assembly downstream of the fuel inlet and upstream of the outlet aperture such that the valve assembly includes a valve member which is moveable along an axis between 1) a closed position in which fluid communication is prevented from the fuel inlet to the outlet aperture and 2) an open position in which fluid communication is provided from the fuel inlet to the outlet aperture. The outlet body includes a 2-dimensional matrix of cells on the downstream surface, the 2-dimensional matrix of cells comprising a finder pattern; a timing pattern; and a field of unpopulated and populated cells which represent bits of data. In a further aspect, an imaginary ray extending outward from the axis bisects the finder pattern.

A method of manufacturing the foregoing fuel injector is provided where the method includes using the 2-dimensional matrix of cells to orient the outlet body relative to the fuel injector body.

### BRIEF DESCRIPTION OF DRAWINGS

This invention will be further described with reference to the accompanying drawings in which:

FIG. 1 is an axial cross-sectional view of a fuel injector in accordance with the present invention;

FIG. 2 is an enlargement of a portion of FIG. 1 shown with a valve assembly in a closed position;

FIG. 3 is the view of FIG. 2 now shown with the valve assembly in an open position;

FIG. 4 is an axial end view of an outlet body of the fuel injector of FIG. 1;

FIG. 5 is an enlargement of a portion of FIG. 4 showing a 2-dimensional matrix of the outlet body;

FIGS. 6 and 7 are views of the fuel injector showing an initial orientation of the outlet body relative to a fuel injector body of the fuel injector and a predetermined orientation between the outlet body and the fuel injector body respectively;

FIG. 8 is a flow chart showing a method of manufacturing the fuel injector; and

FIG. 9 is a flow chart showing an alternative method of manufacturing the fuel injector.

### DETAILED DESCRIPTION OF INVENTION

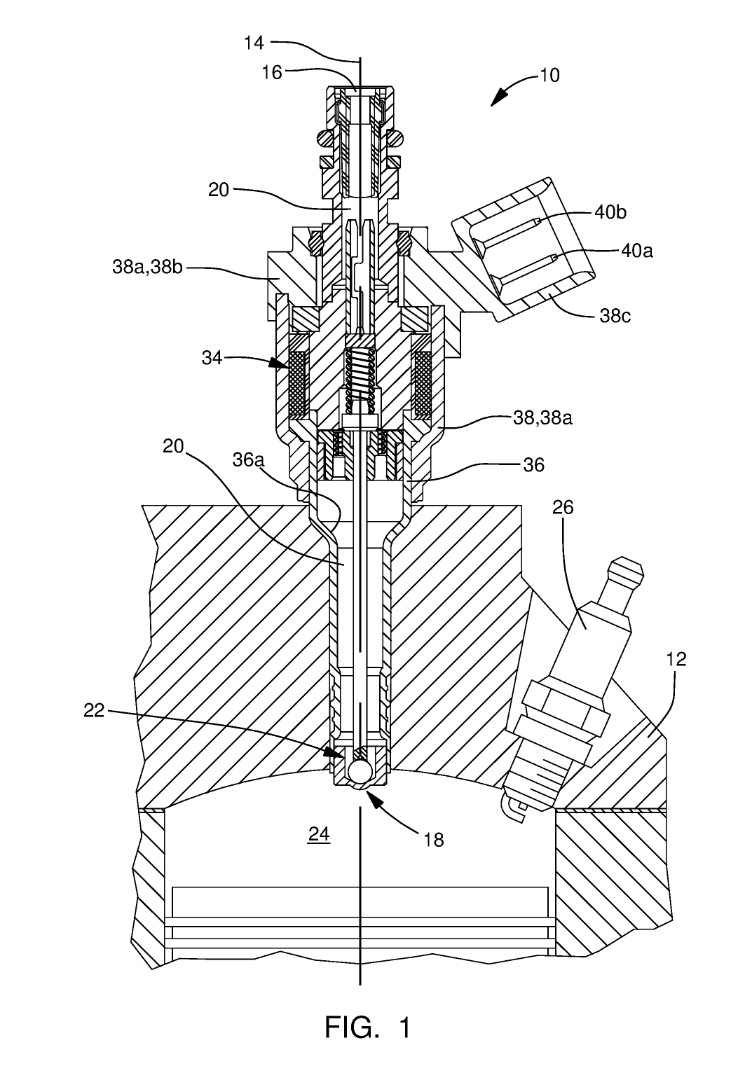

In accordance with a preferred embodiment of this invention and referring to FIG. 1, a fuel injector 10 is shown for supplying fuel to a fuel consuming device which is illustrated as an internal combustion engine 12. Fuel injector 10 extends along a fuel injector axis 14 and includes a fuel inlet 16 which communicates fuel into fuel injector 10, an outlet 18 which dispenses fuel from fuel injector 10, a conduit 20 for communicating fuel from fuel inlet 16 to outlet 18, and a valve assembly 22 for selectively preventing and permitting fuel from exiting outlet 18. Outlet 18 may be disposed within a combustion chamber 24 of internal combustion engine 12 for injection of fuel directly within combustion chamber 24 where the fuel is ignited, for example, by a spark plug 26. It should be noted that the location of fuel injector 10 and spark plug 26 relative to combustion chamber 24 as shown in the figures is for illustrative purposes only and the location of fuel injector 10 and/or spark plug 26 relative to combustion chamber 24 may be vary according to engine design.

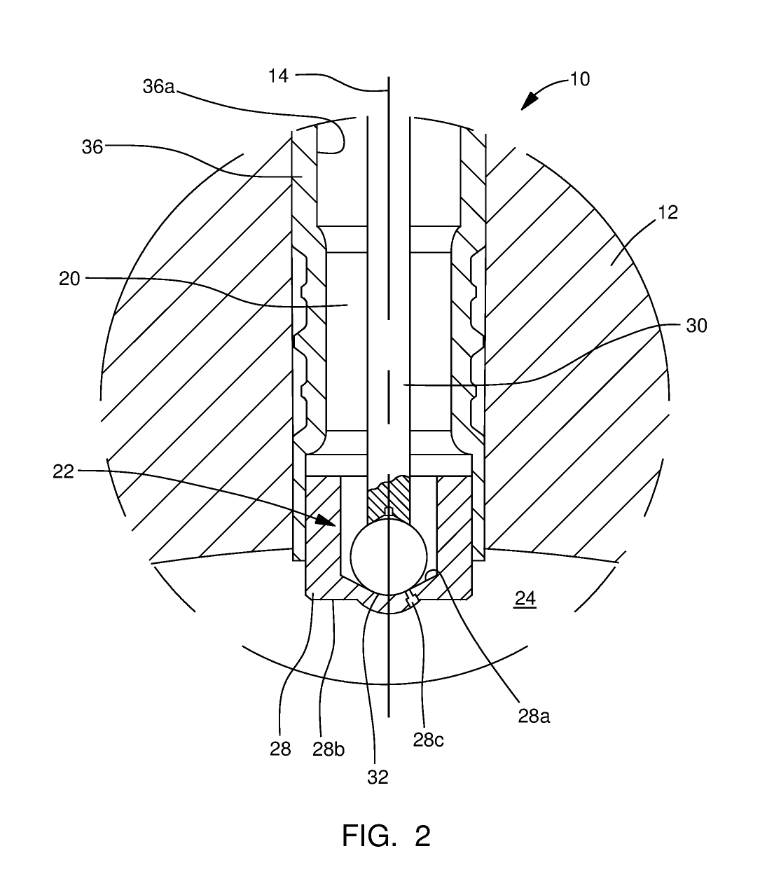

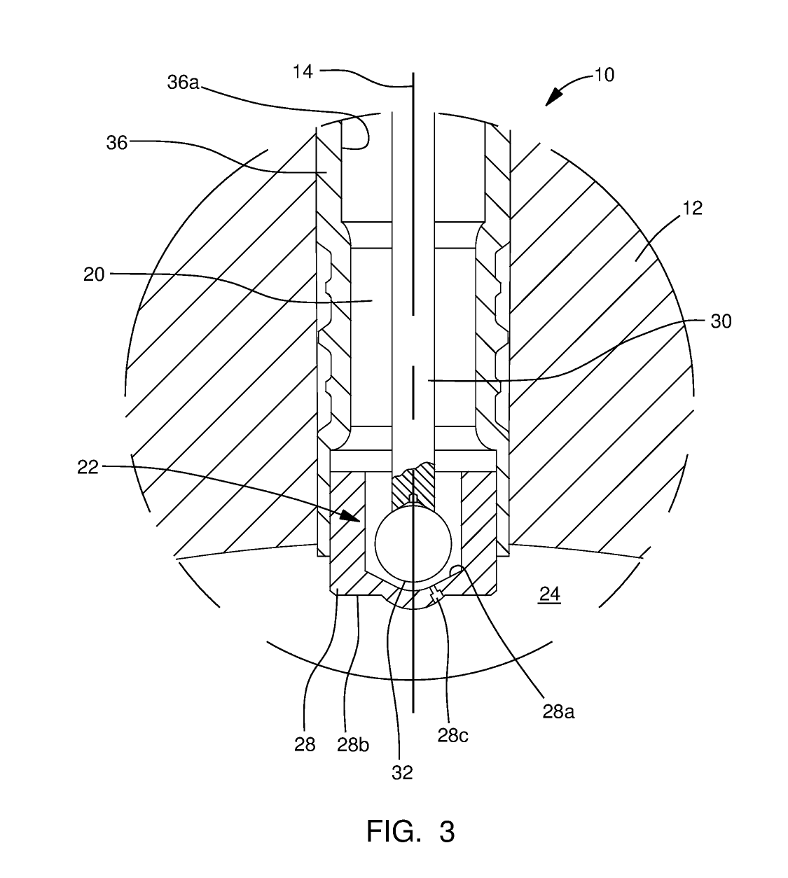

With continued reference to FIG. 1 and with additional reference to FIGS. 2 and 3 which are each an enlarged view of a portion of FIG. 1, valve assembly 22 includes an outlet body, illustrated herein as a valve seat 28 which may be substantially cup-shaped as shown and is made of metal, for example, stainless steel. Valve seat 28 is centered about fuel injector axis 14 and includes an upstream surface 28a, a downstream surface 28b, and outlet 18 which may comprise one or more an outlet apertures 28c fluidly connecting upstream surface 28a and downstream surface 28b. Valve assembly 22 also includes a valve member 30 which is coaxial with valve seat 28 and which defines a valve member seating surface 32 at one end of valve member 30. Valve member 30, and consequently valve member seating surface 32, is reciprocated along fuel injector axis 14 within conduit 20 by an actuator which is illustrated as solenoid 34. Reciprocation of valve member 30 causes valve member seating surface 32 to selectively seat and unseat with valve seat 28 for selectively preventing and permitting fuel flow out of outlet 18. As illustrated in FIG. 2, valve member 30 is shown in a closed position in which fluid communication from fuel inlet 16 to outlet apertures 28c is prevented. Conversely, as illustrated in FIG. 3, valve member 30 is shown in an open position in which fluid communication is proved from fuel inlet 16 to outlet apertures 28c. Actuators for reciprocating a valve member of a fuel injector are well known to those skilled in the art of fuel injectors, consequently, solenoid 34 will not be discussed further herein.

Valve seat 28 is fixed, for example by welding or interference fit, to one end of a fuel injector housing 36 which is made of metal, for example, stainless steel. Fuel injector housing 36 is hollow and includes a fuel injector housing bore 36a extending therethrough such that fuel injector housing bore 36a is centered about, and extends along, fuel injector axis 14 such that a portion of valve seat 28 is received within fuel injector housing bore 36a and such that valve member 30 extends into fuel injector housing bore 36a. The end of fuel injector housing 36 which is opposite from valve seat 28 is fixed to a fuel injector body 38 which may comprise a fuel injector body first portion 38a and a fuel injector body second portion 38b which enclose solenoid 34. Fuel injector body first portion 38a is made of metal and is fixed directly to fuel injector housing 36, for example by welding or interference fit. Fuel injector body first portion 38a is centered about, and extends along fuel injector axis 14. Fuel injector body second portion 38b may be made of plastic which is formed and fixed to fuel injector body first portion 38a in a plastic injection molding operation which overmolds fuel injector body second portion 38b to fuel injector body first portion 38a. Fuel injector body second portion 38b may define an electrical connector 38c which includes electrical terminals 40a and 40b therein which are used to provide electricity to solenoid 34 in use through a complementary mating connector (not shown).

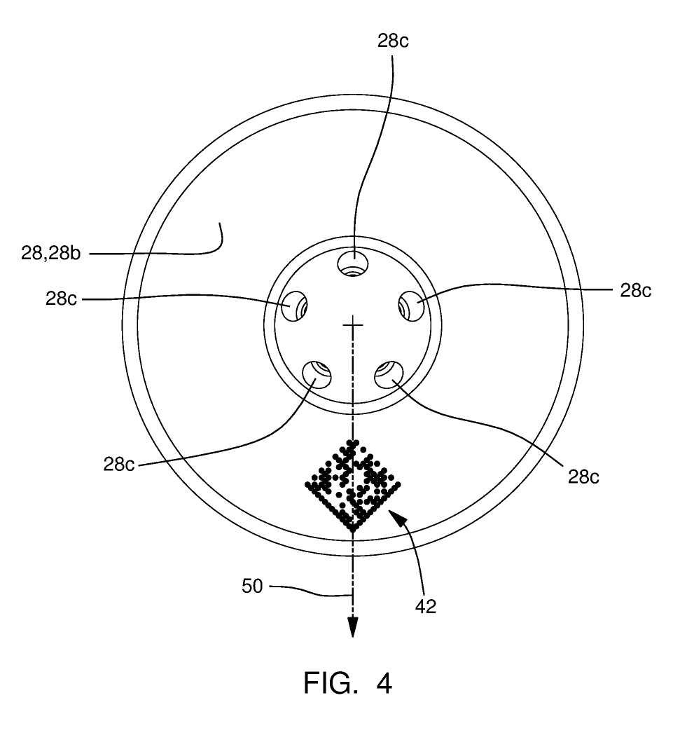

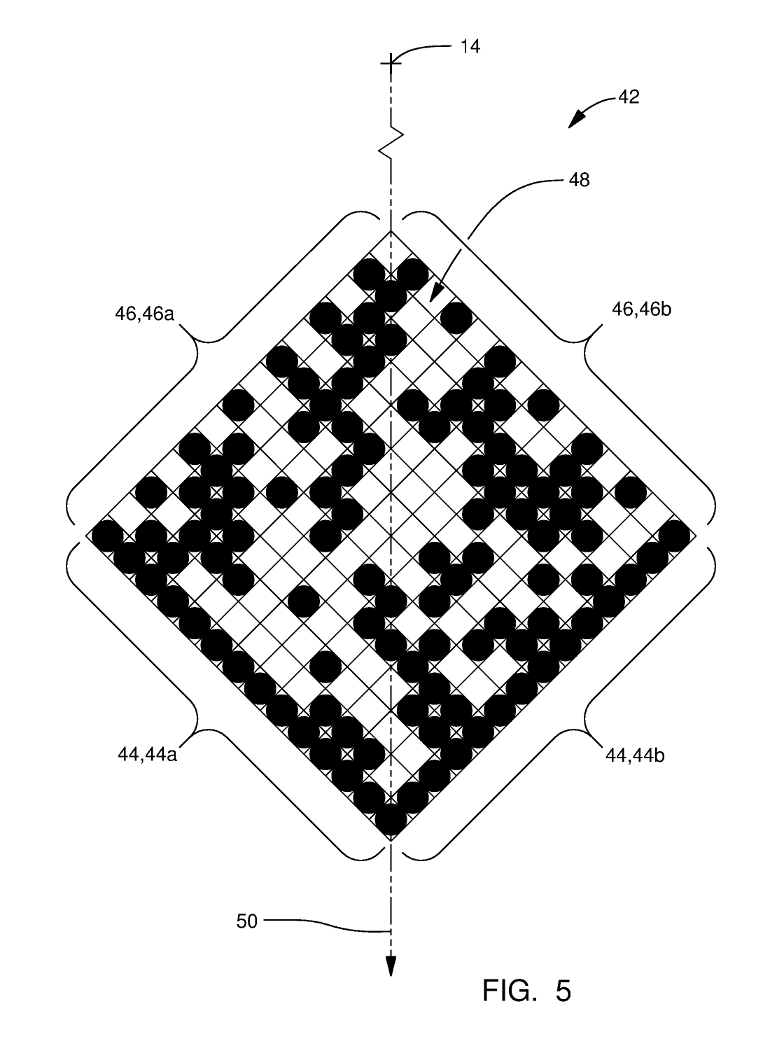

Now with particular reference to FIGS. 4 and 5, valve seat 28 includes a 2-dimensional matrix of cells 42 on downstream surface 28b where the cells are either populated or unpopulated which can be read by a scanner (not shown) which processes 2-dimensinal matrix of cells 42 in order to read the information that has been encoded in 2-dimensional matrix of cells 42 based on which cells are populated and which cells are unpopulated. 2-dimensional matrix of cells 42 includes a perimeter defined at least in part by a finder pattern 44 having a first edge 44a with continuous populated cells and also having a second edge 44b with continuous populated cells adjacent to first edge 44a. First edge 44a and second edge 44b of finder pattern 44 together form a right angle. The perimeter is also defined at least in part by a timing pattern 46 having a third edge 46a with alternating populated cells and unpopulated cells and also having a fourth edge 46b with alternating populated cells and unpopulated cells adjacent to third edge 46a. Third edge 46a and fourth edge 46b of timing pattern 46 together form a right angle. Finder pattern 44 is used by the scanner to locate and orient 2-dimensinal matrix of cells 42 for reading of information provided by 2-dimensional matrix of cells 42 while timing pattern 46 is used by the scanner to provide a count of the number or rows and columns in 2-dimensinal matrix of cells 42. Within the perimeter defined by finder pattern 44 and timing pattern 46 is a field of unpopulated and populated cells 48 which represent bits of data which provide identifying information about one or more of valve seat 28 and fuel injector 10. By way of non-limiting example only, field of unpopulated and populated cells 48 may provide one or more of the following information: date of manufacture, time of manufacture, serial number, part number, identifying information about the machine used to manufacture valve seat 28, style identification, and the like. While 2-dimensinal matrix of cells 42 has been illustrated as having 14 rows and 14 columns, including the rows and columns which are used for finder pattern 44 and timing pattern 46, it should be understood that the number of rows and columns may be selected to accommodate the particular information that 2-dimensinal matrix of cells 42 needs to represent. Furthermore, while field of unpopulated and populated cells 48 has been illustrated with a particular pattern of unpopulated and populated cells, it should be understood that this pattern has been provided for illustrative purposes only. It should be noted that FIG. 5 has been shown with grid lines in order to help visualize the rows and columns, however, it should be understood that these grid lines need not be provided in actual use. While one particular style of matrix has been described with regard to 2-dimensinal matrix of cells 42, it should be understood that other styles may be used, and may be, by way of non-limiting example only, a QR-Code.

It may be desirable to provided outlet apertures 28c in a particular orientation within combustion chamber 24 with respect to fuel injector axis 14 such that a resulting spray pattern/shape from fuel injector 10 is provided within combustion chamber 24 which may be important for desirable combustion of the fuel. Furthermore, the orientation of outlet apertures 28c within combustion chamber 24 may be dictated by interaction between geometries of fuel injector body 38 and internal combustion engine 12. Consequently, it is imperative to properly orient valve seat 28 to a predetermined orientation with fuel injector body 38 during manufacture of fuel injector 10 in order for proper orientation of outlet apertures 28c about fuel injector axis 14 within combustion chamber 24. In order to do so, 2-dimensinal matrix of cells 42 is not only used in the customary manner of storing data, but also as an orientation feature during manufacture of fuel injector 10 to orient valve seat 28 relative to fuel injector body 38 as will be described in greater detail in the paragraphs that follow.

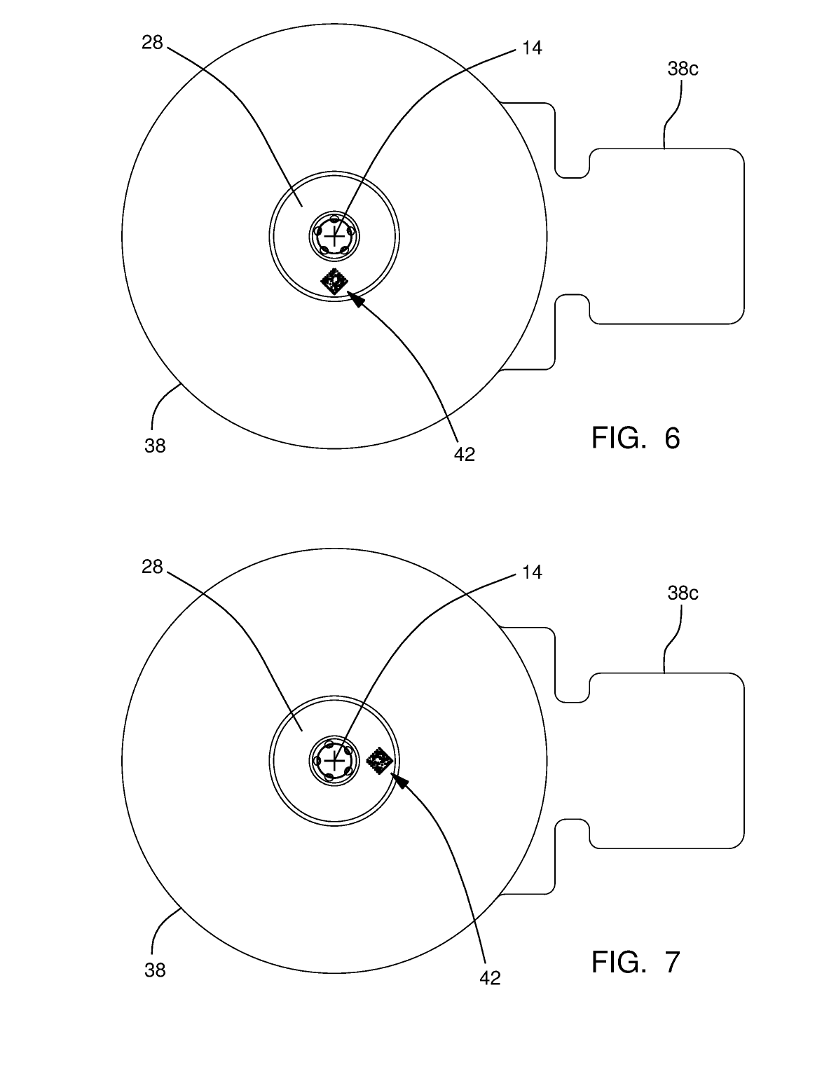

Now with additional reference to FIGS. 6-8, in a first step 100 for using 2-dimensinal matrix of cells 42 to orient valve seat 28 relative to fuel injector body 38, 2-dimensinal matrix of cells 42 is applied to downstream surface 28b, by way of non-limiting example only, by laser etching using a laser (not shown), in a predetermined relationship relative to outlet apertures 28c. It should be noted that the laser used to apply 2-dimensional matrix of cells 42 may be the same laser used in the formation of outlet apertures 28c. As shown, it may be preferable to orient 2-dimensinal matrix of cells 42 such that an imaginary ray 50 extending outward from fuel injector axis 14 bisects the right angle formed by first edge 44a and second edge 44b of finder pattern 44. Furthermore, 2-dimensinal matrix of cells 42 is preferably oriented such that the intersection of first edge 44a and second edge 44b of finder pattern 44 is distal from fuel injector axis 14 while the intersection of third edge 46a and fourth edge 46b of timing pattern 46 is proximal to fuel injector axis 14, consequently, finder pattern 44 acts as an arrowhead in which the vertex converges at a point which is to be used to orient valve seat 28 relative to fuel injector body 38 about fuel injector axis 14.

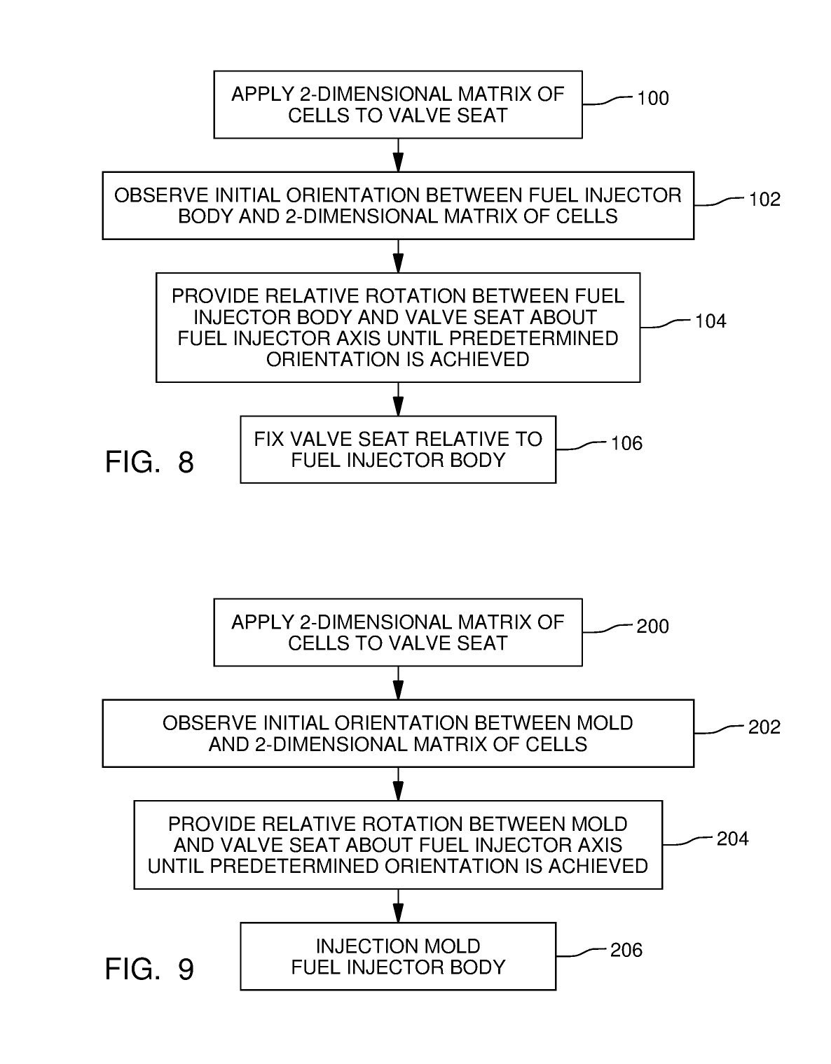

After 2-dimensinal matrix of cells 42 is applied to downstream surface 28b in a predetermined relationship relative to outlet apertures 28c, 2-dimensinal matrix of cells 42 is ready to be used to orient valve seat 28 relative to fuel injector body 38. When fuel injector 10 is being assembled, fuel injector housing 36, and consequently, valve seat 28 is initially able to be rotated relative to fuel injector body 38 about fuel injector axis 14. Consequently, an initial orientation of 2-dimensinal matrix of cells 42, and preferably an initial orientation of finder pattern 44, relative to fuel injector body 38 is observed as shown in FIG. 6 and as represented in step 102 of FIG. 8. Any fixed feature of fuel injector body 38 may be used as a reference when observing the initial orientation of 2-dimensinal matrix of cells 42 relative to fuel injector body 38, however, by way of non-limiting example only, electrical connector 38c may be used as a reference to observe the initial orientation of the initial orientation of 2-dimensinal matrix of cells 42 relative to fuel injector body 38. Observation of the initial position of 2-dimensinal matrix of cells 42 may be accomplished with the human eye, but is preferably accomplished with one or more cameras, scanners, or similar optical devices (not shown) connected to a computer or similar electronic data processing device (not shown). After observing the initial position of 2-dimensinal matrix of cells 42, relative to fuel injector body 38, relative rotation between fuel injector housing 36/valve seat 28 and fuel injector body 38 is provided about fuel injector axis 14. This relative rotation may be provided by human manipulation, but is preferably provided by machinery, for example a rotating chuck (not shown) which rotates fuel injector housing 36/valve seat 28 about fuel injector axis 14 relative to fuel injector body 38 which is held stationary in a fixture (not shown). Relative rotation is provided until a predetermined orientation between valve seat 28 and fuel injector body 38 is achieved based 2-dimensinal matrix of cells 42 relative to fuel injector body 38, and preferably based on finder pattern 44 relative to fuel injector body 38 as shown in FIG. 7 and as represented by step 104 in FIG. 8. The rotating chuck is preferably connected to, and controlled by, the same computer or similar electronic data processing device as the one or more cameras such that the computer or similar electronic data processing device is able to determine the amount of rotation that is needed in order to achieve the predetermined orientation between valve seat 28 and fuel injector body 38.

After the predetermined orientation between valve seat 28 and fuel injector body 38 is achieved, valve seat 28 is fixed relative to fuel injector body 38 in order to maintain the predetermined orientation between valve seat 28 and fuel injector body 38 as represented by step 106 in FIG. 8. This may be accomplished, for example, by welding fuel injector body first portion 38a to fuel injector housing 36 where fuel injector body first portion 38a meets fuel injector housing 36.

In an alternative method of manufacturing fuel injector 10, fuel injector body second portion 38b may be formed in an injection molding operation simultaneously with orienting valve seat 28 relative to fuel injector body 38. When this approach is used, a method as shown in FIG. 9 may be used. In step 200, 2-dimensinal matrix of cells 42 is applied to downstream surface 28b in a predetermined relationship relative to outlet apertures 28c just as in step 100 described previously. Next, in step 202, an initial orientation of 2-dimensinal matrix of cells 42, and preferably an initial orientation of finder pattern 44, relative to a mold (not shown) for injection molding fuel injector body 38 is observed in similar manner as was described relative to step 102. Following step 202, relative rotation between fuel injector housing 36/valve seat 28 and the mold is provided about fuel injector axis 14 until a predetermined orientation between valve seat 28 and the mold is achieved based 2-dimensinal matrix of cells 42 relative to the mold as shown in step 204. Next, in step 206, melted plastic is injected into the mold to form fuel injector body second portion 38b in the predetermined orientation between valve seat 28 and the fuel injector body 38. In this way, 2-dimensinal matrix of cells 42 is used to orient valve seat 28 relative to fuel injector body 38.

While this invention has been described in terms of the preferred embodiments thereof, it is not intended to be so limited, but rather only to the extent set forth in the claims that follow.

We claim:

1. A method of manufacturing a fuel injector for supplying fuel to a fuel consuming device, said fuel injector having a fuel inlet which communicates fuel into said fuel injector; a fuel injector body; an outlet body having an upstream surface, a downstream surface, and an outlet aperture fluidly connecting said upstream surface to said downstream surface; and a valve assembly downstream of said fuel inlet and upstream of said outlet aperture such that said valve assembly is moveable along an axis between 1) a closed position in which fluid communication is prevented from said fuel inlet to said outlet aperture and 2) an open position in which fluid communication is provided from said fuel inlet to said outlet aperture; wherein said outlet body includes a 2-dimensional matrix of cells on said downstream surface, said 2-dimensional matrix of cells comprising a finder pattern, a timing pattern, and a field of unpopulated and populated cells which represent bits of data, said method comprising:
using said 2-dimensional matrix of cells to orient said outlet body relative to said fuel injector body.

2. A method as in claim 1, wherein:
said finder pattern includes a first edge with continuous populated cells and a second edge with continuous populated cells adjacent to said first edge such that said first edge and said second edge form a right angle;
said timing pattern includes a third edge with alternating populated cells and unpopulated cells and a fourth edge with alternating populated cells and unpopulated cells adjacent to said third edge such that said third edge and said fourth edge form a right angle; and
said field of unpopulated and populated cells is within a perimeter defined by said finder pattern and by said timing pattern.

3. A method as in claim 2, wherein using said 2-dimensional matrix of cells to orient said outlet body relative to said fuel injector body comprises:
providing said 2-dimensional matrix of cells on said outlet body in a predetermined relationship relative to said outlet aperture.

4. A method as in claim 3, wherein using said 2-dimensional matrix of cells to orient said outlet body relative to said fuel injector body further comprises using said finder pattern to orient said outlet body relative to said fuel injector body.

5. A method as in claim 4, wherein using said finder pattern to orient said outlet body relative to said fuel injector body comprises the steps of:
i) observing an initial position of said finder pattern relative to said fuel injector body;
ii) providing relative rotation between said fuel injector body and said outlet body about said axis after step i) until a predetermined orientation between said outlet body and said fuel injector body is achieved based on said finder pattern relative to said fuel injector body.

6. A method as in claim 5, further comprising the step of:
iii) fixing said outlet body and said fuel injector body relative to each other after step ii) to maintain said fuel injector body and said outlet body in said predetermined orientation.

7. A method as in claim 2, wherein an imaginary ray extending outward from said axis bisects said right angle formed by said first edge and said second edge.

8. A method as in claim 7, wherein said outlet aperture is eccentric to said axis.

9. A method as in claim 1, wherein using said 2-dimensional matrix of cells further comprises using said finder pattern to orient said outlet body relative to said fuel injector body.

10. A method as in claim 9, wherein using said finder pattern to orient said outlet body relative to said fuel injector body comprises the steps of:
i) observing an initial position of said finder pattern relative to said fuel injector body;
ii) providing relative rotation between said fuel injector body and said outlet body about said axis after step i) until a predetermined orientation between said outlet body and said fuel injector body is achieved based on said finder pattern relative to said fuel injector body.

11. A method as in claim 10, further comprising the step of:
iii) fixing said outlet body and said fuel injector body relative to each other after step ii) to maintain said fuel injector body and said outlet body in said predetermined orientation.

12. A method as in claim 11, wherein an imaginary ray extending outward from said axis bisects said timing pattern.

13. A method as in claim 1, wherein said outlet aperture is eccentric to said axis.

14. A method as in claim 1, wherein using said 2-dimensional matrix of cells to orient said outlet body relative to said fuel injector body comprises the steps of:
i) observing an initial position of said 2-dimensional matrix of cells relative to said fuel injector body;
ii) providing relative rotation between said fuel injector body and said outlet body about said axis after step i) until a predetermined orientation between said outlet body and said fuel injector body is achieved based on said 2-dimensional matrix of cells relative to said fuel injector body.

15. A fuel injector for supplying fuel to a fuel consuming device, said fuel injector comprising:
a fuel inlet which communicates fuel into said fuel injector;
a fuel injector body;
an outlet body having an upstream surface, a downstream surface, and an outlet aperture fluidly connecting said upstream surface to said downstream surface; and
a valve assembly downstream of said fuel inlet and upstream of said outlet aperture such that said valve assembly includes a valve member which is moveable along an axis between 1) a closed position in which fluid communication is prevented from said fuel inlet to said outlet aperture and 2) an open position in which fluid communication is provided from said fuel inlet to said outlet aperture;
wherein said outlet body includes a 2-dimensional matrix of cells on said downstream surface, said 2-dimensional matrix of cells comprising:
a finder pattern;
a timing pattern; and
a field of unpopulated and populated cells represent bits of data;
wherein an imaginary ray extending outward from said axis bisects said finder pattern.

16. A fuel injector as in claim 15, wherein:
said finder pattern includes a first edge with continuous populated cells and a second edge with continuous populated cells adjacent to said first edge such that said first edge and said second edge form a right angle;
said timing pattern includes a third edge with alternating populated cells and unpopulated cells and a fourth edge with alternating populated cells and unpopulated cells adjacent to said third edge such that said third edge and said fourth edge form a right angle;
said field of unpopulated and populated cells is within a perimeter defined by said finder pattern and by said timing pattern; and
said imaginary ray bisects said right angle of said timing pattern.

17. A fuel injector as in claim 16, wherein an intersection of said first edge and said second edge is distal from said axis and an intersection of said third edge and said fourth edge is proximal to said axis.

18. A fuel injector as in claim 17, wherein said outlet aperture is eccentric to said axis.

19. A method for orienting a first member relative to a second member about an axis, said first member having a 2-dimensional matrix of cells thereon, said 2-dimensional matrix of cells comprising a finder pattern; a timing pattern; and a field of unpopulated and populated cells which represent bits of data, said method comprising:
using said 2-dimensional matrix of cells to orient said first member relative to said second member.

20. A method as in claim 19, wherein using said 2-dimensional matrix of cells to orient said first member relative to said second member further comprises using said finder pattern to orient said first member relative to said second member.

21. A method as in claim 20, wherein using said finder pattern to orient said first member relative to said second comprises the steps of:
i) observing an initial position of said finder pattern relative to said second member;
ii) providing relative rotation between said second member and said first member about said axis after step i) until a predetermined orientation between said first member and said second member is achieved based on said finder pattern relative to said second member.

22. A method as in claim 21 further comprising the step of:
iii) fixing said first member and said second member relative to each other after step ii) to maintain said second member and said first member in said predetermined orientation.

23. A method as in claim 22, wherein:
said finder pattern includes a first edge with continuous populated cells and a second edge with continuous populated cells adjacent to said first edge such that said first edge and said second edge form a right angle;
said timing pattern includes a third edge with alternating populated cells and unpopulated cells and a fourth edge with alternating populated cells and unpopulated cells adjacent to said third edge such that said third edge and said fourth edge form a right angle; and
said field of unpopulated and populated cells is within a perimeter defined by said finder pattern and by said timing pattern.

24. A method as in claim 23, wherein an imaginary ray extending outward from said axis bisects said right angle formed by said first edge and said second edge.

25. A method as in claim 19, wherein using said 2-dimensional matrix of cells to orient said first member relative to said second member comprises the steps of:
i) observing an initial position of said 2-dimensional matrix of cells relative to said second member;
ii) providing relative rotation between said second member and said first member about said axis after step i) until a predetermined orientation between said first member and said second member is achieved based on said 2-dimensional matrix of cells relative to said second member.
